(19) United States
(12) Patent Application Publication
(10) Pub. No.: US 2020/0069401 A1
(43) Pub. Date: Mar. 5, 2020

(54) FIBROUS TOOTHPICK

(71) Applicant: CAO GROUP, INC., West Jordan, UT (US)

(72) Inventor: Steven D. Jensen, West Jordan, UT (US)

(21) Appl. No.: 16/489,460

(22) PCT Filed: Feb. 28, 2018
(86) PCT No.: PCT/US18/20213

§ 371 Date: Aug. 28, 2019

Related U.S. Application Data
(60) Provisional application No. 62/465,306, filed on Mar. 1, 2017.

(51) Int. Cl. A61C 15/02

(52) U.S. Cl. CPC A61C 15/02; B05D 1/16

(57) ABSTRACT

A toothpick may comprise a toothpick body having a fibrous flocking material adhered to a surface of the toothpick body.

### CROSS-REFERENCES TO RELATED APPLICATIONS

This application claims the benefit of PCT Application No. PCT/US2018/020213, filed Feb. 28, 2018, which is a non-provisional of U.S. Provisional Application No. 62/465,306 filed on Mar. 1, 2017, each of which is hereby incorporated by reference in its entirety.

### TECHNICAL FIELD OF THE INVENTION

The present invention discloses toothpicks having a fibrous material extending from at least a portion of the surface thereof.

### SUMMARY

The invention discloses toothpicks having a fibrous material extending from at least a portion of the surface thereof.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 depicts an isometric view of a fibrous toothpick body prior to flocking according an embodiment of the present invention.

FIG. 2 depicts an isometric view of the fibrous toothpick body of FIG. 1 with flocking.

FIG. 3 depicts an isometric view of a fibrous toothpick according to another embodiment of the present invention.

### DETAILED DESCRIPTION OF THE INVENTION

Throughout history mankind has utilized many different items to clean between the teeth after a meal, such as floss, toothpick, etc. Dislodging food caught between the teeth is an art form that usually requires multiple attempts to successfully remove a stuck piece. Toothpicks whether wood or plastic often require a person to dig out stuck food a piece at a time regardless of their design. Floss also at times requires multiple attempts to remove food stuck in the same tooth. Contemporary floss and toothpicks fail in that their surfaces are smooth and the materials they are made from become slick when they become wet with saliva; they tend to pierce or slide through the stuck food instead of removing it. There are some plastic toothpicks with friction ridges molded into the pick, which are intended to aid in removing food but unfortunately end up behaving more like a rasp.

What are needed are soft toothpicks that fill in the anatomical gap between teeth and simply push the food out. The present invention utilizes fibers that are adhered to a toothpick of various designs, wherein the fibers aid in filling the anatomical gap such that stuck food is forced out when pushed through the gap between teeth.

One embodiment of the present invention is a toothpick that is fiber flocked at one end; thereby creating a handle end and a pick end, wherein the handle is utilized to grasp and manipulate the toothpick and the fiber flocked end is utilized to push through the gaps between teeth.

An embodiment of the present invention utilizes the process known as “flocking” as a means to attach fibers to a toothpick of any design. First, an uncured adhesive is applied to the areas that are to receive the fibrous material, and then fibers are applied to the surface at random usually within an enclosure wherein fibers are blown by a circulation of air. An electrostatic charge is applied forcing the fibers to stand upright such that one end of the fiber remains in the uncured adhesive and the length of the fiber extends substantially perpendicular to the surface to which it is adhered. Second, the adhesive is cured by way of light, heat or any other curing method into a finished toothpick. A flocked item will have the appearance of a thin fuzz or fur layer on the finished product. The characteristics of the flocked layer are adjustable by varying the length, thickness, and composition of the fibers.

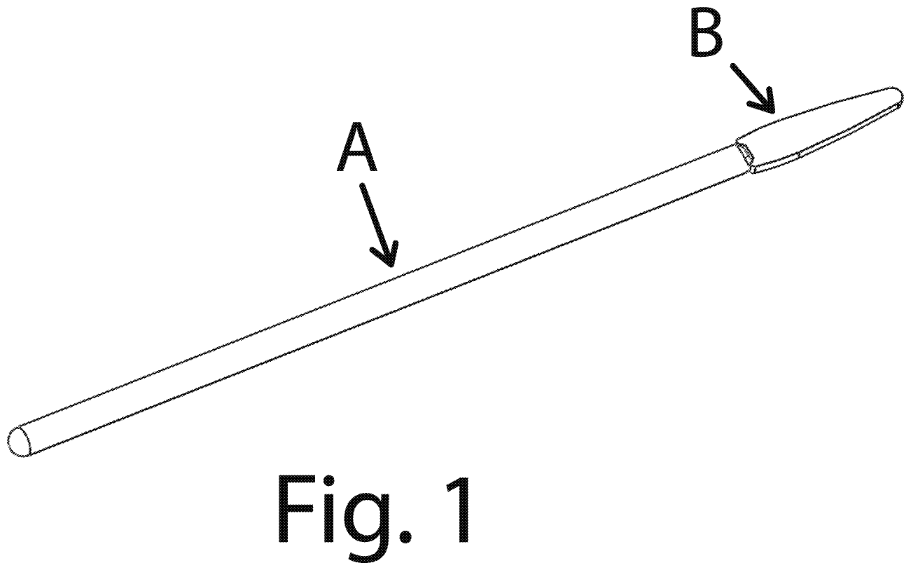

FIG. 1 depicts a toothpick body according to an embodiment of the present invention. The toothpick body of FIG. 1 includes a handle end A that is designed to be grasped by a hand in order to manipulate a pick end B. The pick end B is designed to fit within the anatomical gaps between teeth. There is no limit to the shape, size, or composition of the pick end B as long as it fits within a gap between teeth. Any pick end that can fit within a gap between teeth is within the scope of this patent.

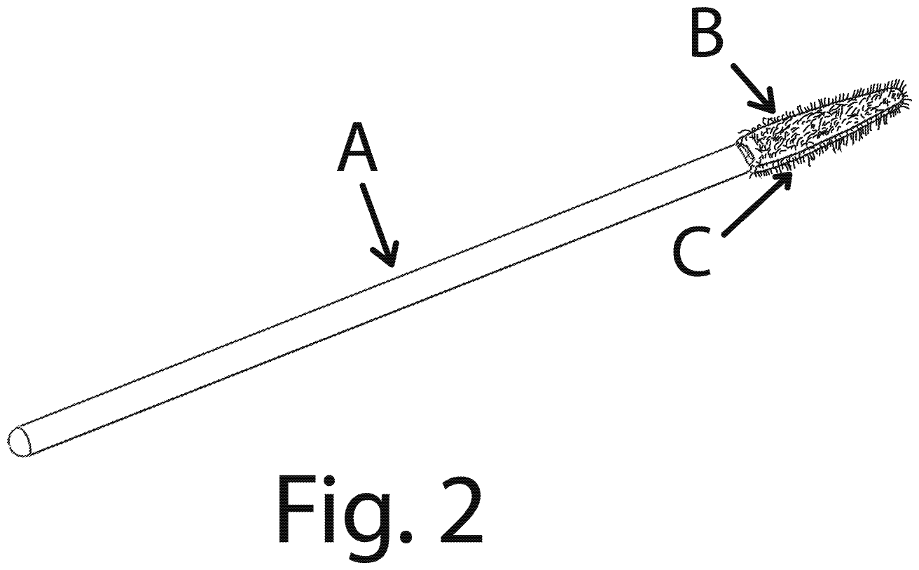

FIG. 2 depicts the toothpick body of FIG. 1 after a flocking has been applied to the pick end B. The pick end B is covered in a fiber flocking C as depicted in FIG. 2.

In some embodiments, fibers may flock the entire surface of a toothpick body. In additional embodiments, fibers may flock only a portion of the toothpick, such as a pick end.

Some embodiments of the present invention utilize polymers to create the un-flocked toothpick body. Polymers such as: polypropylene, polyethylene, nylon, ABS, PVA, polyacrylate, polycarbonate or any other useful polymer.

Some embodiments of the present invention utilize polymer filaments as a flocking material. The polymer filaments can be made from polymers such as: polypropylene, polyethylene, nylon, ABS, polyacrylate, PVA or any other useful polymer.

Some embodiments of the present invention utilize at least one of light-cured adhesives, temperature sensitive adhesives, pressure sensitive adhesives, temperature cured adhesives, solvent evaporation adhesives, and chemical cured adhesive to adhere a fiber flocking material to a surface of a toothpick body.

Some embodiments of the present invention utilize a flat spade design pick end, such as depicted by pick end B of FIG. 1. In some embodiments, a flat spade design pick end may be flocked with a fiber flocking, such as depicted by pick end B covered in fiber flocking C in FIG. 2.

Some embodiments of the present invention utilize a cylindrical handle as depicted by handle end A shown in FIG. 1.

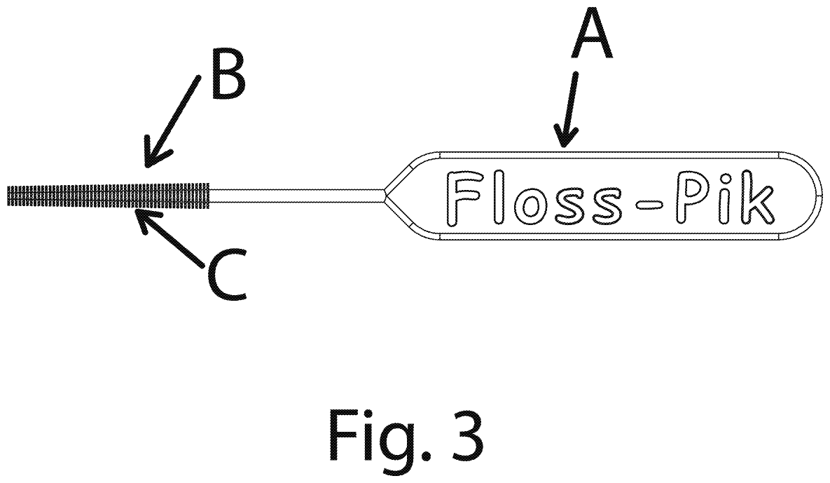

In some embodiments, a fibrous toothpick may include a handle A that is substantially flat and a pick end B with a substantially cylindrical shaft and a frustroconical end portion, as shown in FIG. 3. Fiber flocking C may be applied to the surface of the frustroconical end portion of the pick end B.

What is claimed is:

1. A toothpick comprising:
a toothpick body; and
fiber flocking adhered to a surface of the toothpick body.
